(19) United States
(12) Patent Application Publication
(10) Pub. No.: US 2024/0224085 A1
(43) Pub. Date: Jul. 4, 2024

(54) Multiplexing for Edgeless Networks

(71) Applicant: Celona, Inc., Campbell, CA (US)

(72) Inventors: Srinivasan Balasubramanian, San Diego, CA (US); Puneet Prabhakar Shetty, San Francisco, CA (US); Sushanth Ck, Campbell, CA (US); Atchuta Rallapalli, Campbell, CA (US)

(21) Appl. No.: 18/397,134

(22) Filed: Dec. 27, 2023

Related U.S. Application Data
(60) Provisional application No. 63/478,303, filed on Jan. 3, 2023.

(51) Int. Cl. H04W 24/04; H04W 28/086

(52) U.S. Cl. CPC H04W 24/04; H04W 28/0862

(57) ABSTRACT

Various embodiments of a method and apparatus for using S1/N2/N3 Flex features are disclosed. A single tunnel is established between the AP (Access Point) and an SNRN (S1/N2/N3 Routing Node). The SNRN multiplexes between different core network components, which in some embodiments include the MME (Mobility Management Entity), the SGW (Serving Gateway), the Access Mobility Management Function (AMF) and the UPF (User Plane Function) to connect the AP (via the SNRN) to as multiple other components (nodes and functions) of the core. Since each AP does not need to support more than one tunnel, the overhead on the AP is kept minimal, while still supporting S1/N2/N3 Flex connectivity. Since multiplexing between the SNRN and different components of the core is simpler than establishing a tunnel between an AP to those components of the core, recovery from a failure of a core network component is simplified and less likely to cause an outage.

### CLAIM OF PRIORITY TO PREVIOUSLY FILED PROVISIONAL APPLICATION—INCORPORATION BY REFERENCE

This non-provisional application claims priority to an earlier-filed provisional application No. 63/478,303 filed Jan. 3, 2023, entitled “Multiplexing for Edgeless Networks” (ATTY DOCKET NO. CEL-068-PROV), and all its contents, are hereby incorporated by reference herein as if set forth in full.

### (1) TECHNICAL FIELD

The disclosed method and apparatus relate generally to wireless communication systems and more particularly to multiplexing for edgeless networks.

### (2) BACKGROUND

5G network architecture provides faster communications, allowing larger amounts of data to be transferred. However, there is room for improvement in reliability and usage of features of 5G LTE (Long Term Evolved).

### Network

FIG. 1 illustrates an LTE and an NR (New Radio) network architecture 100. The NR network architecture 100 includes a UE (User Equipment) 102, APs (Access Points) 104, 106, an NSSF (Network Slice Selection Function) 108, an AUSF (Authentication Server Function) 110, a UDM (Unified Data Management) 112, an AMF (Access Mobility Management Function) 114, an SMF (Session Management Function) 116, a PCF (Policy Control Function) 118, an AF (Application Function) 120, an NRF (Network Repository Function) 121, a UPF (User Plane Function) 122, a UPF Anchor 124, a UPF Anchor 126, a DN (Data Network) 128, an SGW (Serving Gateway) 130, a PGW (Packet Data Network Gateway) 132, an MME (Mobility Management Entity) 134, an HSS (Home Subscriber Server) 136, a PCRF (Policy and Charging Rules Function) 138, an Internet/Intranet 140 and an Operator IP Services 142.

The NSSF 108, the AUSF 110, the UDM 112, the AMF 114, the SMF 116, the PCF 118, the AF 120 and the NRF 121 are part of a 5G SBA (Service Based Architecture).

The NR network architecture 100 supports establishing multiple connections with the UE 102, via the APs 104 and 106 (as part of providing a connection between a service and the UE 102). In some embodiments, one or both of the APs 104 and 106 are gNBs (gNobeBs) or eNBs (eNodeBs). The UE 102 may also establish an N1 interface with core network components, such as the AMF 114. Similarly, the APs 104 and 106 may establish multiple S1/N2/N3 interfaces. For example, in some embodiments, the AP 104 establishes an N2 interface with the AMF 114 and an N3 interface with the UPF 122. Similarly, the AP 106 may establish an S1-U interface with the SGW 114 and an S1-C interface with the MME 134.

The NSSF 108 selects an NSI (Network Slicing Instance) and determines available and appropriate NSSAI (Network Slice Selection Assistance Information) for a requested connection or service. The NSSF 108 sets the AMF 114 to serve the UE 104 via the NSI selected.

The AUSF 110 determines subscriber authentication information associated with the UE 102. The AUSF 110 obtains stored authentication information by interacting with the UDM 112 in response to an authentication request and authenticates the UE 102, determining whether to grant access to network resources.

The UDM 112 stores authentication information and subscription information. UDM 112 provides information needed for an ACRPF (Authentication Credential Repository and Processing Function), stores the long-term security credentials used in authentication, and stores subscription information.

The AMF 114 is a control plane function. The AMF 114 performs mobility management. The AMF 114 handles the registration of the UE 102 and manages connections, which provide service to the UE 102. Connection and session-related information are received by the AMF 114. Messages associated with session management are sent to the SMF 116. The AMF 114 implements a NAS (Non-Access Stratum) ciphering and integrity protection. To find available instances of the SMF 116 that are accessible in the network, the AMF 114 queries the NRF 121. The AMF 114 oversees handovers of connections between APs (where the connection is handed from one AP to another AP). The AMF 114 collects information about available SMFs from the UE 102. The AMF 114 can retrieve an NRF, NSI ID and target AMFs as part of initially registering the UE 102 and as part of establishing a PDU (Protocol Data Unit).

The SMF 116 is a 5G SBA. SMF 116 interacts with a data plane and allocates an IP address or manages the allocation of an IP address to the UE 102. In some embodiments, the SMF 116 manages PDU sessions by creating, updating and removing PDU sessions. The SMF 116 manages tunnels that use a GTP (GPRS—General Packet Radio Service—Tunnel Protocol). The SMF 116 manages session contexts with the UPF.

The PCF 118 manages the service policy. The AF 120 provides session-related information to the PCF 118 in support of generating PCC (Policy Charging and Control) rules.

The NRF 121 facilitates determining what services are provided by a Network Function (NF). In some embodiments, the NRF 121 is a centralized repository for NFs. The NFs register with the NRF 121, which provides an API (Application Interface) for the NFs to discover one another.

The UPF 122 provides a connection point between the mobile infrastructure and the DN 128. The UPF 122 provides encapsulation and decapsulation of GTP-U (GPRS—General Packet Radio Service—Tunnelling Protocol for the User plane). The UPF 122 provides a PDU session anchor point for providing mobility for RATs (Radio Access Technologies). The UPF 122 forwards and routes packets. When acting as an I-UPF (Intermediate-UPF) to more than one PSA (PDU Session Anchor), the UPF 122 acts as a UL-CL (Uplink Classifier or Upload Classifier) and a branching point. In some embodiments, the PSA is the UPF that terminates the N6 interface of a PDU session within a 5G core network of FIG. 1. In some embodiments, the UPF 122 detects applications with SDF (Service Data Flow) traffic filter templates. In some embodiments, the UPF 122 detects applications using/detecting protocols by detecting server-side IP addresses and port numbers, which make up the Packet Flow Description (PFD). The PFD is received from the SMF 116. The UPF 122 handles QoS (Quality of Service) on a per-flow basis. The UPF 122 marks packets for UL (Uplink or Upload) and DL (Downlink or Download) at the transport level. The UPF 122 marks rate limits and provides a QoS DSCP (Differential Service Control Point) marking to a packet during the DL (the DSCP is appended to the header of a packet to mark the packet as eligible for a particular forwarding treatment).

The UPF 122 reports traffic usage. The UPF 122 allows the PGW control and user plane functions to be separated, allowing the data forwarding to be handled by multiple components (each component can be referred to as an element and can be a node, and in some embodiments can be a function provided at a node and in some embodiments can be a compute instance provided by a node). The UPF 122 processes packets for the SBAs.

Messages from the UPF 122 travel through one of the UPF Anchor 124 or UPF Anchor 126. The DN 128 identifies services of service providers, Internet access and third-party services.

The SGW 130 resides in the UP. The SGW 130 routes packets to and from the APs and the PGW. The SGW 130 also serves as the local mobility anchor when transferring ongoing communications from one AP to another (or inter-AP handovers).

The PGW 132 provides connectivity from the UE 102 to external PDNs (Packet Data Networks). The PGW 132 is a point of exit and entry of traffic. The UE 102 may be simultaneously connected to more than one PGW 132 to allow for simultaneous access to multiple packet data networks. For each user, the PGW 132 performs policy enforcement, packet filtering, charging support and packet screening. The PGW 132 provides an interface between LTE and other technologies.

The MME 134 provides mobility session management for the NR network architecture 100, supporting subscriber authentication, roaming and handovers to other networks.

The HSS 136 is a database that contains user-related and subscription-related information. The functions of the HSS 136 include mobility management, call and session establishment support, user authentication and access authorization.

The PCRF 138 manages the service policy. The PCRF 138 also sends information about QoS settings for user sessions. The PCRF 138 determines real-time policy rules in the network. The PCRF 138 accesses subscriber databases and a charging system. The PCRF 138 facilitates aggregating information to and from the network, operation support systems and other sources (such as portals) in real-time. The aggregated information is used to create rules and then automatically decide policy issues for subscribers active on the network. The PCRF 138 provides multiple services, QoS levels and charging rules. The PCRF 138 can also be integrated with different platforms such as billing, rating, charging and subscriber databases or can also be deployed as a standalone entity.

In some embodiments, the Internet/Intranet 140 is a combination of a LAN (Local Area Network) and a WAN (Wide Area Network). The LAN includes an enterprise network. In some embodiments, the Operator IP Services 142 includes machines (i.e., servers and network devices) and software that provide one or more services to the enterprise.

### Ran Architecture

Referring to FIG. 2, in the first variant of a RAN architecture 200, there are multiple RUs (Radio hardware Units) communicatively connected to a DU (Distributed Unit). Similarly, multiple DUs are connected to the CU (Central Unit)—the CU communicates with the edge. In the example embodiment of FIG. 2, the RU 202 is connected to the DU 204, while the RU 206 is connected to the DU 208. Both the DU 204 and 208 are connected to CU 210. Also, RU 212 is connected, via the DU 208, to the CU 210. The CU 210 functions as an AP. The CU 210 connects directly to edge 214, thereby allowing each RU, via a DU connected to a CU, to interact with the edge 214 and thereby allowing different variations of gNBs to be integrated and communicate with the edge 214 by a single AP. However, each RU may receive communications from a variety of UEs. The larger the varieties of UEs that utilize the same AP, the greater the likelihood that the core network components that best serve each are in different locations and in different components in the core network.

Referring to FIG. 3, in the second variant 300, in contrast to the system of FIG. 2, in some embodiments, an RU 314 is connected directly with an edge 306, and a DU 304 may be connected directly to the edge 306. In the second variant 300, the functions provided by the CUs or the combination of the DUs and the CUs are provided by the edge 306, when desired, thereby “offloading” the gNB functions to the edge 306.

### Edge Computing

Edge computing refers to the practice of performing computing services at an edge network so that the computations are performed close to the data or close to where the results or needed to reduce latency.

### S1, N1 AND N2 MULTIPLEXING (S1/N2/N3 FLEX)

FIG. 4 illustrates a diagram of an S1/N2/N3 interface 400 having flex features. The interface 400 includes APs 402a and 402b (i.e., eNB or gNB, respectively), AMFs 404a, UPFs 404b, SGWs 404c and MMEs 404d. Each of the APs 402a and 402b is allowed to be associated with multiple core network components (the MMEs 404a/the SGWs 404b and the AMFs 404c/the UPFs 404d).

The SGW 404c performs the functions performed by the SGW 130, and the MME 404d performs the functions performed by the MME 134. Traffic from the UEs that are “camped” (or located) at a given AP is distributed amongst the core network components. Placing the UEs at a given AP requires multiple secure tunnels to be established from the core network components to the APs 402a and 4042b. Establishing multiple secure tunnels gives the system 400 some degree of flexibility, and which core network components are used by a UE can be changed if one core network component fails.

However, each AP is limited regarding the number of IP Sec (Internet Protocol Secure) tunnels that can be supported.

Referring to the systems of FIGS. 4, for example, to take advantage of the flex features of 5G LTE, the S1/N2/N3 interface establishes connections to determine the individual network functions of the edge network architecture that are available to the APs. The APs are informed of changes to the allocation of the individual network functions. Specifically, S1/N2/N3 Flex feature requires the APs to establish S1/N2/N3 connections to the individual network functions of network components—the MMEs 404a/SGWs 404b and the AMFs 404c/UPFs 404d (FIG. 4). Also, in cloud computing, the makeup of the networks of the cloud currently being relied upon can change unexpectedly, which at times can require the AP to establish a new connection to a different cloud resource. The network connections need to be established (or reestablished) with the modified locations of these functions. The APs need to be informed of the changes to the allocation of the individual network functions of the MME/SGW and the AMF/UPF in the edge network. To correct the failure, the connections need to be reestablished with the modified locations of these functions. However, at times, communications may be interrupted by a failure of a core network component, causing an outage of an AP, until the AP can establish a tunnel connection with another core network component. Consequently, the failure of a single core network component can cause an outage of an AP.

An approach is needed that does not have the limitations of an individual AP to support tunnels to core network functions. A system and method are needed that are not susceptible to single points of failure to take advantage of the Flex features of 5G LTE. A system and method are needed that are not adversely affected by the changes in the allocation of network functions.

### SUMMARY

Various embodiments of a method and apparatus for using the flexible features of S1/N2/N3 Flex are disclosed.

A core network component is established to which a tunnel with an AP is established. The core network component is referred to as an SNRN (S1/N2/N3 Routing Node). The AP is then connected, via the SNRN, to as many other components (nodes and functions) of the core (the MME/SGW/AMF/UPF) that the AP would like to access. The SNRN multiplexes between the other core network components to connect the AP to those core network components. Since each AP only needs to support one tunnel, the overhead on the AP is reduced, and in some embodiments, is kept minimal, while still supporting the S1/N2/N3 Flex connectivity. Since multiplexing between the SNRN and different components of the core (that is, having the SNRN perform multiplexing) is simpler than establishing a tunnel between an AP to those components of the core, recovery from a failure of a core network component is simplified and less likely to cause an outage. When a core network component fails or is likely to fail soon, the SNRN establishes a connection with another core network component of the same type, which provides the services previously provided by the failing core network component.

In some embodiments, the loads from the UEs located at a given AP are distributed, by the SNRN, amongst the core network components to balance the load. In some embodiments, the APs assigned to a particular core network component (e.g., to a particular AMF or MME) are determined to keep each core network component's load balanced. The SNRN is also made HA (Highly Available) to prevent, or reduce the likelihood of, a single point of failure causing an outage of the AP.

In some embodiments, the SNRN is implemented as a router (or, in some embodiments, a collection of routers) by forwarding the packets to the appropriate component on both DL and UL directions to the appropriate core network component. In some embodiments, the router reads the packet headers at the kernel level, thereby avoiding bringing the packet into the main memory. By multiplexing, via the SNRN, the APs are abstracted from, and thereby insulated from disruptions in communications that would otherwise result from, the dynamic adaptations that involve moving services out of the edge and between one core network component and another.

Connecting the APs to the core network components, via the SNRN, reduces, and in some embodiments minimizes, the support the APs need to provide for the S1/N2/N3 Flex feature. The SNRN supports the S1/N2/N3 Flex features while using APs that are only capable of establishing a single connection into the core. The SNRN allows each AP to be associated with multiple core network components (the MME/SGW and the AMF/UPF) simultaneously, despite any given AP supporting only a single connection. Additionally, a given core network component is allowed to service multiple APs.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 illustrates a prior art LTE and NR (New Radio) network architecture that is capable of implementing S1/N2/N3 Flex features.

FIG. 2 illustrates a first variant of a prior art RAN (Radio Access Network) architecture.

FIG. 3 illustrates a second variant of a prior art RAN architecture.

FIG. 4 illustrates a prior art S1 and N2 multiplexing, which applies to S1/N2/N3 Flex.

FIG. 5 illustrates some embodiments of multiplexing with an SNRN (S1/N2/N3 Routing Node).

FIG. 6 illustrates some embodiments of cloud breathing.

FIG. 7 illustrates some embodiments of a network device used for implementing the method and system of FIGS. 5-10.

FIG. 8 illustrates a flowchart of some embodiments of a method of communicating, via an SNRN, with a network.

FIG. 9 illustrates a flowchart of some embodiments of a method of handling a core network component failure.

FIG. 10 illustrates a flowchart of some embodiments of a method of integrating the SNRN with an NRF (Network Repository Function).

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

Edgeless computing refers to processes that do not rely on edge computing. In some embodiments, approaches are provided for S1/N2/N3 (1800 MHz/1900 MHZ, frequency bands) Flex features, which support dynamically moving services from the edge to a public cloud (and other dynamic edgeless adaptations). Some embodiments minimize the features an AP is required to have to utilize S1/N2/N3 Flex features. Some embodiments help enable the S1/N2/N3 Flex features without requiring the APs to support more than one tunnel into the core.

### Modified S1 and N2 Multiplexing

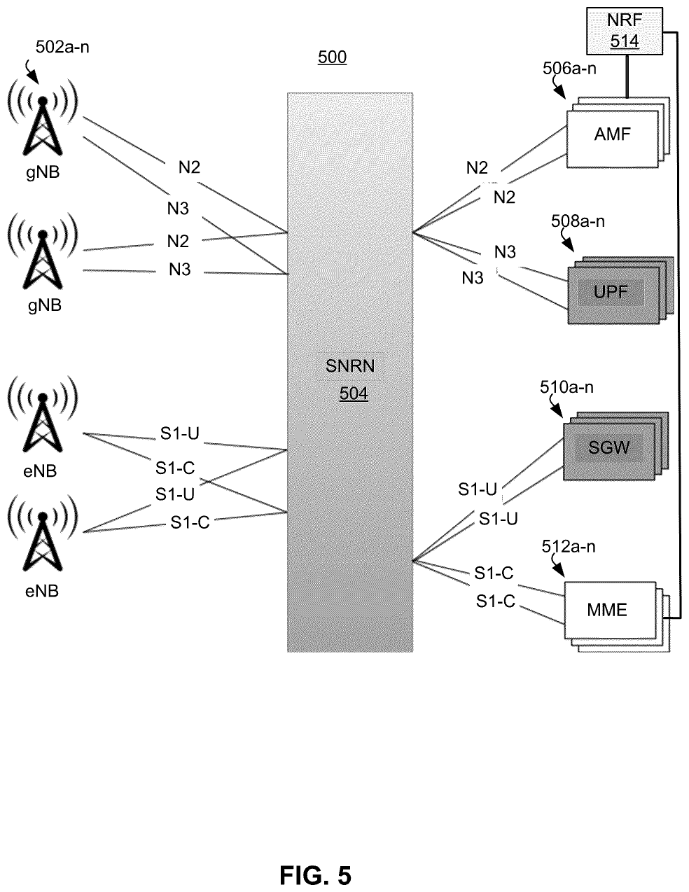

FIG. 5 illustrates a block diagram of an S1/N2/N3 multiplexing system 500. The S1/N2/N3 multiplexing system 500 includes APs 502a-n, an SNRN (S1/N2/N3 Routing Node) 504, and core network components including AMFs 506a-n, UPFs 508a-n, SGWs 510a-n, MMEs 512a-n and an NRF (Network Repository Function) 514.

In the embodiment of FIG. 5, nodes 502a-n communicate, via S1-C and S1-U interfaces, with the SNRN 504. The SNRN 504 communicates, via N2 interfaces, with the AMFs 506a-n. The SNRN 504 communicates, via N3 interfaces, with the UPFs 508a-n. The SNRN 504 communicates, via S1-U interfaces, with the SGWs 510a-n. The SNRN 504 communicates, via S1-C interfaces, with the MMEs 512a-n.

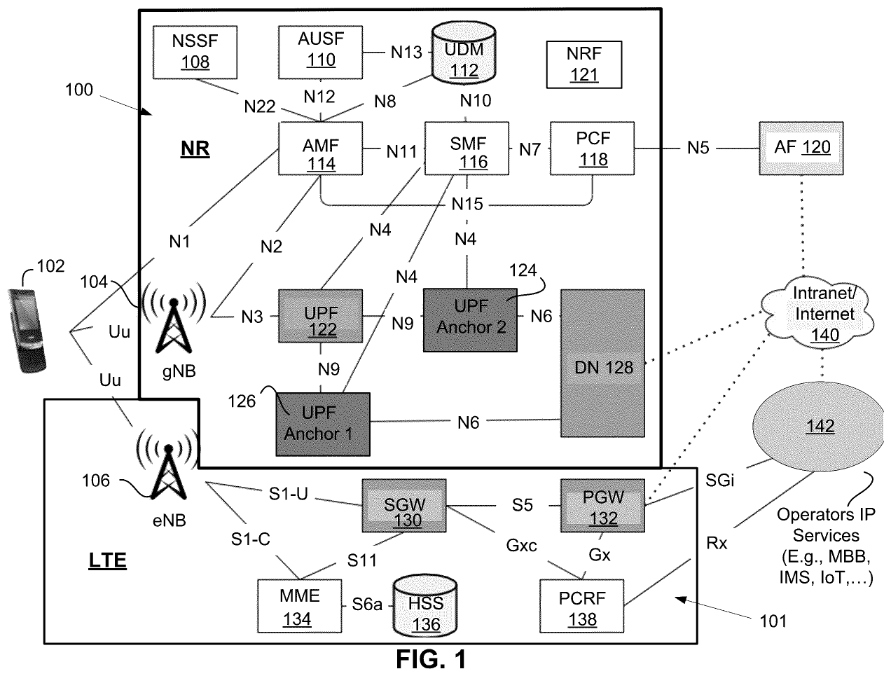

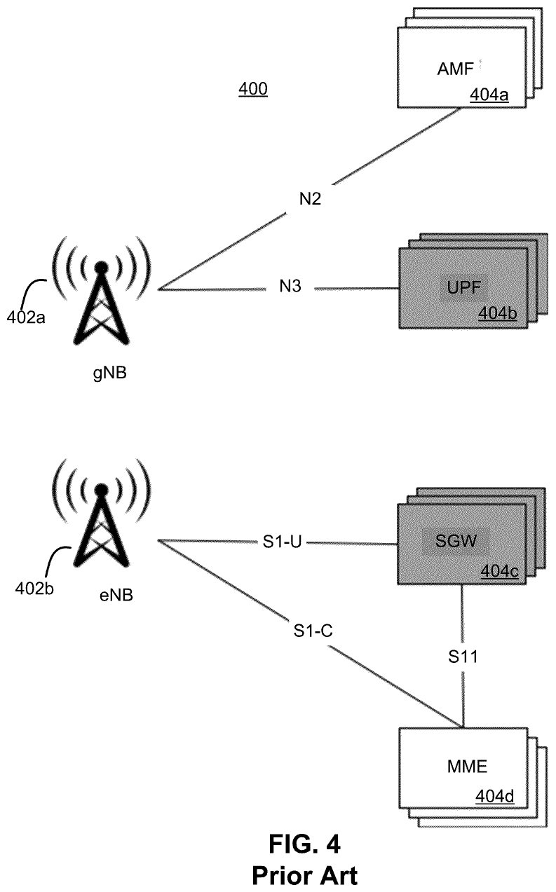

The S1/N2/N3 multiplexing system 500 can be deployed within the systems of FIGS. 1-4 and 6 to facilitate usage of Flex features. The APs 502a-n receive messages from the UE 102. In some embodiments, the APs 502a-n are versions of the APs 104 and 106.

In the embodiment of FIG. 5, each of the APs 502a-n is not required to establish multiple tunnels to communicate with multiple core network components. Instead, the SNRN 504 multiplexes between the multiple core network components with which it is desirable to connect to a given AP. Accordingly, instead of running the tunnel for the S1/N2 Flex multiplexing from the APs 502a-n directly to the AMFs 506a-n, UPFs 508a-n, SGWs 510a-n, MMEs 512a-n, the tunnel is run to the SNRN 504. Additionally, the S1/N2/N3 Flex multiplexing is by the SNRN 504 to the desired core network components (which in at least some embodiments include the AMFs 506a-n, the UPFs 508a-n, the SGWs 510a-n and the MMEs 512a-n). The decoupling of the APs 502a-n from the multiplexing keeps the overhead on any of the individual APs 502a-n minimal while still supporting the S1/N2/N3 Flex connectivity, reducing the likelihood of a failure of a single core network component from causing a total outage as a result of the failure of any given AP. In some embodiments, the SNRN 504 can be implemented at the edge 214 or 306.

In some embodiments, the SNRN 504 includes a service-location-and-routing function that determines a location of a core network component, via which a particular service is provided, and routes communications from APs to an appropriate compute-function of a core network component. For example, a message may include header information indicating a type of service requested associated with the communication, and the SNRN 504 maintains a table for locations of components having compute nodes that best handle that microslice.

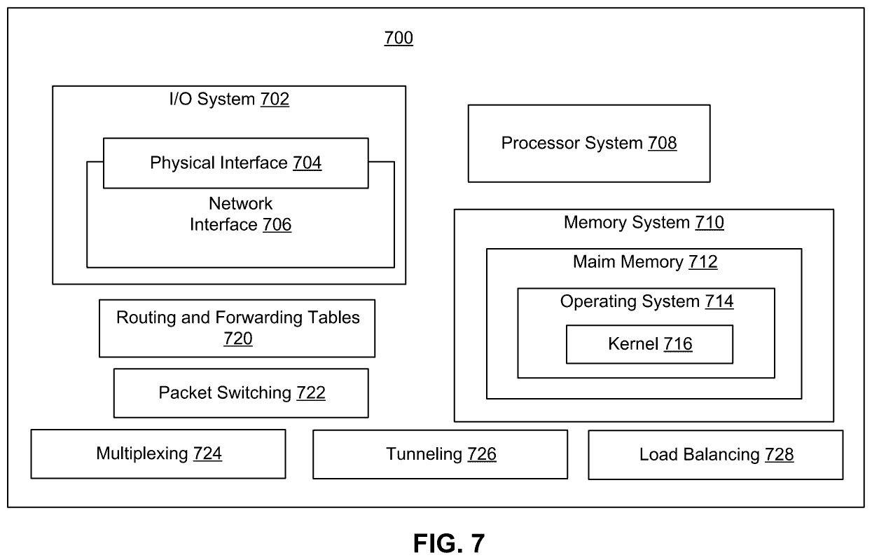

Some embodiments in which SNRN 504 is a router are discussed, below, with FIG. 7.

SNRN Integration with an NRF (Network Repository Function)

The NRF 514 is a centralized repository for 5G NFs (Network Functions). The NFs register with the NRF 514, which provides an API (Application Interface) for the NFs to discover one another. In some embodiments, the NRF 514 is a locator for the different core network functions that are located in an SBA.

The AMFs 506a-n (and MMEs 512a-n) register with the NRF 514, so as to integrate the SNRN 504 with the NRF 514. To integrate the SNRN 504 with the NRF 514, the AMF stores the UE context and provides the information about the AMF to the SNRN 504, via which a more appropriate AMF (e.g., an AMF closer to the UE, closer to the resources needed to satisfy the UE's requests or an AMF that has a lighter load) can be allocated to the UE.

### SNRN Support for Cloud Breathing

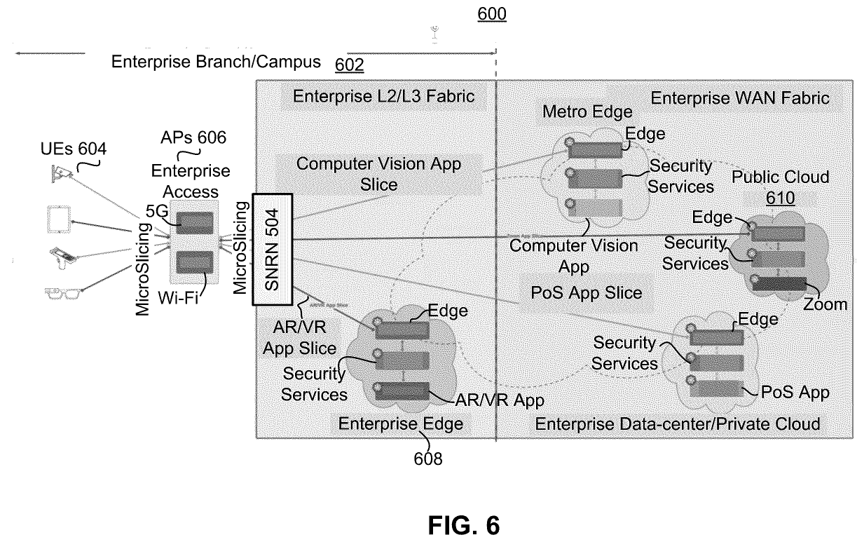

FIG. 6 illustrates an embodiment of cloud breathing, in a network 600. The network 600 includes the SNRN 504, a campus 602, UEs 604, APs 606, an enterprise edge 608 and a public cloud 610.

Network 600 is an example of NR network architecture 100. The campus 602 is the campus (i.e., branch) of an enterprise. The UEs 604 are devices camped on the campus. UEs 604 are examples of UE 104. In some embodiments, the portion of FIG. 5 to the left of the SNRN 504 is in the enterprise campus 602, which is not within the enterprise 608. In some embodiments, the portion to the right of the SNRN 504 is within the portion of FIG. 1 to the right of the N1, the N2 and the S1 interfaces and is the portion of FIG. 6 that is within the enterprise edge 608 and the public cloud 610. In the example of FIG. 5, the UEs 604 include different types of user equipment, and each type of UE uses a different microslice to connect to the network. The APs 606 are the access points used by the UEs 604 for accessing the network. The enterprise edge 608 is the network equipment that belongs to the enterprise. In some embodiments, APs 606 establish connections, via the microslices, with components of enterprise edge 608 and public cloud 610. In some embodiments, enterprise 608 is an on-premises compute platform.

As illustrated in FIG. 6, the enterprise edge 608 is located within the enterprise campus 602. By contrast, public cloud 610 represents portions of the public network that are being used by the enterprise (but is not part of the enterprise edge 608). The public cloud 610 includes computing resources available on-demand to the enterprise. In the embodiment of the network 600, microservices can be moved from components of the enterprise edge 608 to the public cloud 610 and back. In the network 600, the SNRN 504 is placed between the AP and the enterprise edge 608 or in the enterprise edge 608.

Moving services (and microservices) to the public cloud 610 from the edge 608 is termed “breathing out.” Moving the services from the public cloud 610 back to the edge 608 is referred to as “breathing in.” “Cloud bursting” is an application configuration that allows the private cloud to “burst” into the public cloud and access additional computing resources at network components in the public cloud without service interruption. The cloud bursts can be triggered automatically in reaction to high-demand usage or by a manual request. When breathing out, the UE's context is copied to a target component in the cloud, and then the SNRN 504 establishes a connection with the target component and terminates the connection with the current component in the edge. When breathing in, the UE's context is copied to a target component (e.g., in the edge), and then the SNRN 504 establishes a connection with the target component and terminates the connection with the current component (in the cloud).

Several triggers regulate the transitions (i.e., the handovers associated with cloud bursting) between network components, which include roaming, limitations of on-premise components, cost and SLAs for a given application. Other triggers include changes in the availability of the component (hosting the application(s)) and changes in the availability of other resources being accessed and a change in the APs 606 to which the UE connects. The transitions can also be performed hierarchically, ensuring that UEs entitled to higher levels of service receive higher levels of service, by connecting the UEs entitled to higher levels of service to core network components that are closer to the UE and that have a lower load. The on-premise components are optimized by keeping compute instances performed on the component close to the APs 606 by which the UEs 604 access the network. The on-premise compute instance moves further away from the APs 606 when there are other constraints in the system.

In some embodiments, multiple levels of SLA are supported. In some embodiments, the SLA is relaxed when there are constraints on the network or when the network resources are stressed, for example. When the SLA is relaxed, the enforcement of the SLA is switched to the cloud from a local, on-premise component using a subdued SLA. The SLA is returned to the local on-premise component when the capacity constraints are removed. In the prior systems, without the use of SNRN 504, when switching which core network component is used for providing a service, the AP would need to establish a new tunnel to a new core network component. However, since each AP can only support one tunnel, establishing new tunnels encumbers switching between enterprise edge cloud 608 and usage of the public cloud 610 and back and encumbers usage of Flex features.

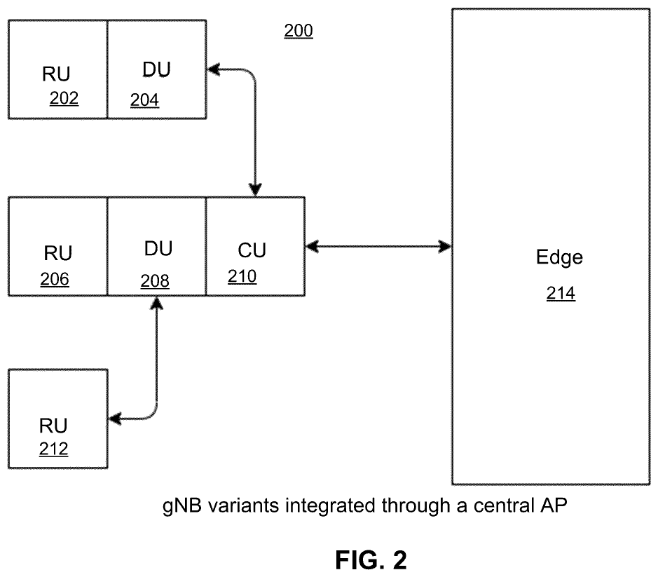

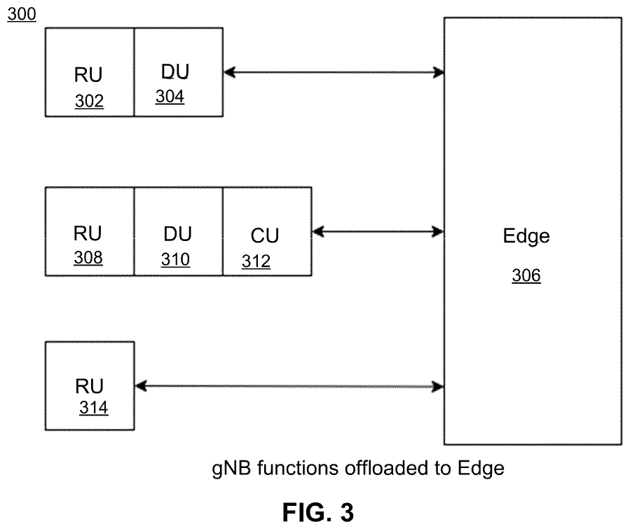

In some embodiments, in the system 600, to overcome the limited number of tunnels that are supported by each AP, the SNRN 504 is placed between the APs 606 and the edge 608. The SNRN 504 can be implemented with any of the configurations of FIGS. 2 and 3. For example, in some embodiments, during cloud breathing, CU and DU functions that have been offloaded to the enterprise edge 608 could be offloaded to the public cloud 610, which can be performed smoothly by temporarily connecting the AP to two redundant CU or DU services, simultaneously, one located in the enterprise edge 608 and one located in the public cloud 610, during the transition between the two, even if the AP can only support one tunnel. In some embodiments, temporarily having two redundant connections (one in the enterprise edge 608 and one in the public cloud 610), while breathing in or breathing out, reduces the likelihood of an occurrence of a noticeable disruption.

The cloud breathing can be implemented by selectively moving a specific UE's context to the appropriate AMF/UPF. For example, the UE's context can be moved from an AMF/UPF that is in the enterprise network (which includes the enterprise campus 602 and the enterprise edge 608) to one that is in the cloud or from an AMF/UPF that is in the cloud to one that is in the enterprise network. A user plane connection can be moved across the A-UPF and the Intermediate-UPF. In some embodiments, the SMF 112 needs to be informed of the change of the AMF that is servicing a given UE.

### Some Embodiments of a Network Device

FIG. 7 shows a block diagram of an embodiment of a network device 700, which in some embodiments is used to implement the SNRN 504 and, in some embodiments, is SNRN 504. In some embodiments, the network device 700 includes at least an I/O (Input/Output) system 702 having at least one physical interface 704 that is associated with the network interface 706, a processor system 708 and a memory system 710. The memory system 710 includes a main memory 712, which has an operating system 714 with a kernel 716. In some embodiments, the network device 700 includes routing and forwarding tables 720 and a packet switching module 722 (for handling packet switching). The networking device 700 also includes a multiplexing module 724 and in some embodiments includes a tunneling module 726 and a load balancing module 728.

In some embodiments, the network device 700 is a router. The network device 700 causes the tunnel to be established to the APs and multiplexes communications to the core network components. The I/O system 702 controls incoming and outgoing messages. The physical interface 704 is a physical connection to the network (the Intranet/Internet 140 or the public cloud 610) and to the enterprise network (the enterprise campus 602). In some embodiments, the network interface module 706 is a network card or another network interface module with similar functions. The network interface module 706 processes incoming packets and determines where to send the incoming packets. The network interface module 706 forwards the incoming packets to local devices via the processors. The network interface module 706 receives packets, at a packet switch, from the network and forwards the packets to another device in the network. In some embodiments, the physical interface 702 includes multiple input and output ports.

The processor system 708 implements the methods of FIGS. 5-10. The processor system 708 implements machine instructions stored in the memory system 710.

If the network device 700 is a router, the processor system 708 determines the next destination for the packets and then, in some embodiments, returns the packets to the network interface module 706. In some embodiments, when a group of packets originate from the same source and are headed for the same destination, one packet from the group is processed by the processor system 708, and the remaining packets are processed by the network interface module 706 without being sent to the processor system 708. The network interface module 706 is configured to determine how to process other packets of the group based on the packet from the group that was processed by the processor system 708. In some embodiments, the processor system 708 includes multiple processors. In some embodiments, the processor system 708 includes an interface to a console, such as a personal computer or game console. In some embodiments, the processor system 708 includes a microprocessor.

In some embodiments, the memory system 710 includes volatile (but non-transient) memory, nonvolatile memory, processor cache, memory buffers, queues for storing packets waiting to be processed, working memory and program memory. In some embodiments, the memory system 710 includes multiple forms of memory of the network device 700. In some embodiments, the memory system 710 stores information and instructions related to implementing protocols (for forwarding encapsulated packets for network device 700) that determine whether to allow a packet to pass from one network and/or device to another and/or what device in the network to forward the packet to (e.g., based on a hop distance). In some embodiments, the memory system 710 includes algorithms/protocols for implementing any of the modules of the network device 700. In some embodiments, the memory system 710 includes algorithms/protocols for receiving packets, reading packet headers, forwarding packets to core network components, forwarding packets to the APs 104 and 106, load balancing, and establishing tunnels between the APs 104 and 106 and network device 700.

In some embodiments, some incoming packets from a first port are copied into the main memory 712, and the copies are sent by a second port to another location.

The routing and forwarding tables 720 are included in embodiments of network device 700 that are used as routers. In some embodiments, the routing and forwarding tables 720 include a packet forwarding table. The routing and forwarding tables 720 store the different paths to reach various network components and the resource cost (i.e., the transit time) of the different paths. The routing and forwarding tables 720 help network device 700 find alternative paths for communications, which helps ensure that a failure of one component does not cause a failure of a communication or an AP.

In some embodiments in which the network device 700 is a router, the network device 700 forwards packets to an appropriate component on both the DL and the UL directions. The network device 700 reads the packet headers at the kernel level and avoids bringing the packet into the router's main memory. In some embodiments, the service-location-and-routing function uses the routing and forwarding tables 720 to facilitate finding core network components of particular types and to route communications to a core network component that was found.

The packet switching module 722 connects the network interface 706 to the network and/or to the processor. The packet switching module 722 determines which outgoing path or port to send an incoming packet to. In some embodiments, when using the network device 700, the packet can be routed to a destination (in some embodiments, via packet switch 722) without being copied to the main memory 712 (based on the protocol of the network device 700). In some embodiments, the routing and forwarding tables 720 and the packet switching module 722 are hardwired. In some embodiments, the packet switching module 722 and the routing and forwarding tables 720 are implemented in software.

The multiplexing module 724 performs the multiplexing that is used to connect an individual AP to multiple core network components (the multiplexing was discussed above in connection with FIG. 5).

Tunneling module 726 is the portion of the tunneling algorithm that is resident at network device 700 that aids in establishing tunnel connections with the APs 602a-n. In some embodiments, tunneling module 726 establishes tunnel connections to the core network components with which the APs 602a-n communicate (via the network device 700). By establishing a tunnel to the SNRN 504, the limitations on the number of IP Sec (Internet Protocol Security) tunnels that the APs 502a-n can support are reduced, improving S1/N2/N3 multiplexing. By using the SNR 504, the AP is only required to establish one tunnel, and the only tunnel the AP needs to establish to a core network component is a tunnel to the SNR 504. In some embodiments, there is only a single tunnel established between each AP and the SNR 504, and the SNR 504 establishes tunnel connections to the core network components.

Load balancing module 728 balances the loads from the APs 602a-n that are sent, via network device 700, to the core network components, supporting multiple APs (i.e., APs 502a-n). In selecting the appropriate AMF, the network device 700 performs the load-balancing function on a per UE basis, based on the loading information and the performance requirements for the UE/UE-flows. Generic UEs without specific types can be employed. In some embodiments, different algorithms for load balancing and assigning UE to core network components are employed based on the UE/subscription type or real-time criteria. Keeping the core network components load-balanced (each servicing its fair share of the load generated by APs 602a-n) while still supporting the S1/N2/N3 Flex connectivity reduces the likelihood of, and in some embodiments prevents, a single core network component failure from causing an outage at any given one of the APs 602a-n. In some embodiments, the AP can also be changed, and the core network component that acts as the network device 700 can be changed to enhance flex features further.

In some embodiments, the network device 700 is also made HA (Highly Available) to prevent a single point of failure. In some embodiments, a VRRP (Virtual Router Redundancy Protocol) helps ensure that the network device 700 is HA. Keeping the network device 700 HA facilitates quickly rebalancing the loads in response to changes in traffic, and rerouting communications to another core network component (another of the AMFs 506a-n, the UPFs 508a-n, the SGWs 510a-n and the MMEs 512a-n) when one of the core network components fails or malfunctions. In some embodiments, the VRRP maintains active virtual components (i.e., a virtual node) and other virtual components that are redundant to the active virtual components, to facilitate changing the active virtual component if needed. In some embodiments, the VRRP dynamically assigns responsibility for a failing virtual component of the network device 700 to another virtual component. In some embodiments, the VRRP maintains groups of virtual components in which one of the virtual components of the group is active, and the others are redundant to the active virtual component. In some embodiments, the redundant component that replaces the failing component is part of the same group of virtual components.

### Method of Communicating Via the SNRN

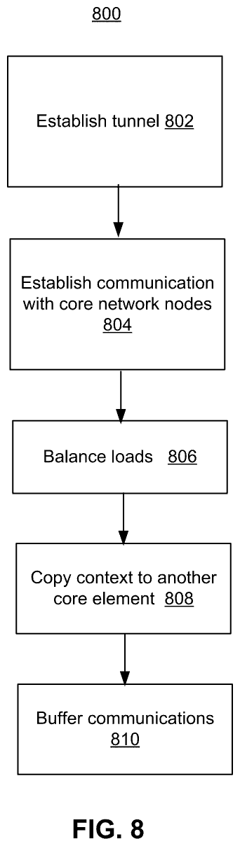

FIG. 8 illustrates a method 800 of communicating with a network via the SNRN 504. In a step 802, a tunnel is established between one of the APs 502a-n and the SNRN 504 (step 802, the SNRN 504 allows each AP to establish a separate tunnel). In a step 804, the SNRN 504 establishes a connection with a core network component, which in some embodiments is one of the AMFs 506a-n, the UPFs 508a-n, the SGWs 510a-n and the MMEs 512a-n. In the step 804, the SNRN 504 establishes connections between the AP and multiple core network components, and the SNRN 504 multiplexes between the core network components, as needed. In a step 806, the SNRN 504 load balances the core network components (the AMFs 506a-n, the UPFs 508a-n, the SGWs 510a-n and the MMEs 512a-n), balancing the number of UEs handled by a given core network component. In some embodiments, in a step 808, a copy of the context information is stored at another of the core network components (other than the core network component currently in use) in case of a component failure. In a step 810, the control/user plane data, and in some embodiments other communications data, traveling in the UL direction, are stored, by the SNRN 504, in buffers of the SNRN 504 (temporarily storing the message information in buffers of SNRN 504). By buffering the data, if there is an interruption, the control/user plane data is not lost, and the session can be repaired. The steps 804, 806, 808 and 810 are not necessarily performed in the order listed or sequentially.

### Method for Handling a Component Failure

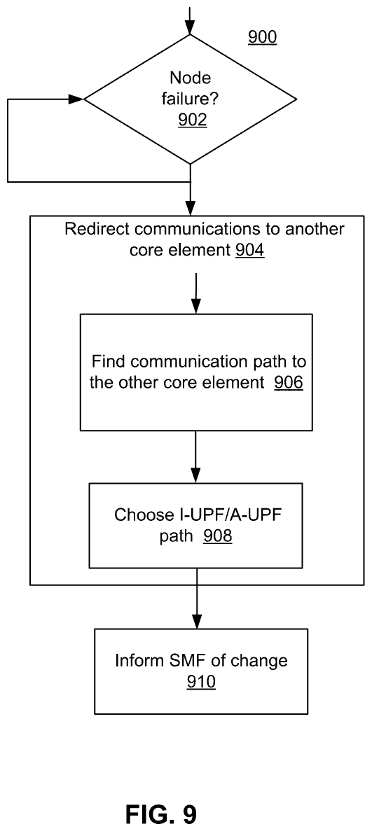

FIG. 9 illustrates a method 900 for handling a core network component failure (i.e., a failure of one of the AMFs 506a-n, the UPFs 508a-n, the SGWs 610a-n and the MMEs 512a-n). In a step 902, a determination is made, by the SNRN 504, whether a core network component failed or is predicted to fail. If no failure is detected or predicted, the step 902 is repeated. If in the step 902, a failure is detected by the SNRN 504, then in a step 904, the communication is redirected to another component. In some embodiments, the component to which the communication is rerouted has a copy of the context (as a result of step 808 of method 800), and in some embodiments, the component is sent a copy of the context. In a substep 906 (of the step 904), a communication path is found to the other core network component.

In some embodiments, the substep 906 includes adding (or inducing) one or more additional hops in paths of control signals or within a UP (User Plane). For example, in some embodiments, after making an initial hop toward a core network component, a message is rerouted toward the replacement core network component. In some embodiments, as part of the step 906, the SNRN 504 chooses between using an I-UPF or connecting directly to an A-UPF. The SNRN 504 can choose between using an I-UPF versus going directly to A-UPF. As part of step 906, in at least some instances or embodiments, the connection needs to be released (e.g., as soon as possible) and reestablished when a component failure detection occurs.

Method of Integrating the SNRN with the NRF

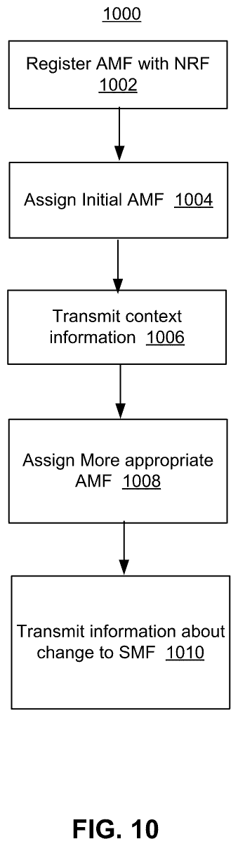

FIG. 10 illustrates a method 1000 of integrating the SNRN 504 with an NRF. In the method 1000, in a step 1002, the AMFs 506a-n register with the NRF, so as to integrate the SNRN 504 with the NRF.

In a step 1004, an initial AMF 506a-n is assigned to the UE.

In a step 1006, the SNRN 504 transmits the UE context and provides the relevant information to determine a more appropriate allocation of the AMF 506a-n after the initial choice of the AMF 506a-n. In some embodiments, the relevant information includes the load currently being handled by the AMF, the location of the AMF, the SLA, an identification of a type of UE, and an expected QoS.

In a step 1008, a more appropriate AMF is assigned to the UE, based on the information supplied in step 1006. In some embodiments, in a step 1010, the SMF is informed of the change of the AMF 506a-n.

### Extending Multiplexing to Core Network Components

Referring again to FIG. 1, there are many interfaces other than just the S1/N2/N3 interfaces at which multiplexing and load balancing can be beneficial. In some embodiments, a multiplexing component, similar to SNRN 504, is used for interfaces other than S1/N2/N3 (i.e., the multiplexing component handles N4-N22, S5, S6a, S11, Gx or Gxc interfaces). In other words, in some embodiments, a multiplexing component (similar to SNRN 504) is inserted between a set of network components (which in some embodiments are core network components) and multiple core network components. In some embodiments, the multiplexing component also performs load balancing. Multiplexing and the load balancing at other interfaces within the core network further protect communications against single component failures that might otherwise cause outages.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, components or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method comprising:
establishing a communication between an AP (Access Point) and a core network component, by
establishing a tunnel between an SNRN (S1/N2/N3 routing node) and an AP; and
establishing a within-core-communication, via the SNRN to a core network component,
therein communicatively connecting a UE (User Equipment), via the AP and the SNRN, to the core network component.

2. The method of claim 1, wherein the SNRN supports S1/N2/N3 Flex connectivity.

3. The method of claim 1, wherein the SNRN is implemented at an edge network.

4. The method of claim 1 further comprises balancing, by the SNRN, a load, associated with communications with core network components, between the AP and one or more other APs.

5. The method of claim 1 further comprising:
detecting an issue with the core network component, and
in response, redirecting a core-communication from the core network component to another core network component, therein preventing an outage of an AP as a result of a single-node failure.

6. The method of claim 5 further comprising:
the other core network component storing a copy of a context of the UE before the detecting of the issue.

7. The method of claim 1 further comprising:
transferring at least some network operations to components of a public cloud by transferring a UE context from a core network component of a given type residing in a local area network to a core network component of the given type residing in the public cloud.

8. The method of claim 1, wherein:
the SNRN includes a router that forwards packets to an appropriate node in a DL (Download) direction and a UL (Upload) direction.

9. The method of claim 1,
the router having a main memory; wherein,
the router reads a packet header of a packet, the packet header being read at a kernel level while avoiding bringing the packet into the main memory.

10. The method of claim 1 further comprising:
registering an AMF (Access Mobility Management Function) with an NRF (Network Repository Function).

11. The method of claim 1 further comprising:
the SNRN choosing between establishing communications with an (I-UPF (Intermediate-User Plane Function) and with an A-UPF (Anchor UPF).

12. A network system comprising:
a. network device, including
i. a processor system having one or more processors and
ii. a memory system;
b. the memory system storing one or more machine instructions, which, when implemented by the processor system, cause the processor system to
establish multiple secure communications between UE (User Equipment) and a network core by
establishing a tunnel between an SNRN (S1/N2/N3 Routing Node) and an AP (Access Point); and
establishing within-core-communications, from the SNRN to multiple core network components, therein communicatively connecting the UE, via the SNRN, to the multiple core network components.

13. The network system of claim 12, wherein the SNRN supports S1/N2/N3 Flex connectivity.

14. The network system of claim 12, wherein the one or more instructions cause the processor system to implement the SNRN at an edge.

15. The system of claim 12, the one or more instructions cause the processor system to perform load-balancing, by the SNRN, by balancing a communications load between the AP and one or more other APs.

16. The network system of claim 12, the one or more instructions cause the processor system to:
detect an issue with the core network component, and
in response, redirect a core-communication from the core network component to another core network component, therein preventing an outage of an AP due to a single-node failure.

17. The network system of claim 16,
the other core network component storing a context of the UE, prior to detecting the issue.

18. The network system of claim 12,
the one or more instructions cause the processor system to transfer at least some network operations to components of a cloud by transferring a UE context from a core network component of a given type residing in a local area network to a core network component of the given type residing in a public cloud.

19. The network system of claim 12, wherein:
the SNRN includes a router that forwards packets to an appropriate node in a DL (Download) direction and a UL (Upload) direction.

20. The network system of claim 12,
the SNRN being a router,
the one or more instructions, when implemented, cause the router to read a packet header
at a kernel level while avoiding bringing the packet into the main memory.

21.-22. (canceled)
